(19) United States
(12) Patent Application Publication
(10) Pub. No.: US 2007/0097117 A1
(43) Pub. Date: May 3, 2007

(54) Automated mesh creation method for injection molding flow simulation

(75) Inventors: Ching-Chang Chien, Hsinchu City (TW); Cheng-Yung Liu, Hsinchu City (TW); Chia-Hsiang Hsu, Hsinchu City (TW)

Correspondence Address: BACON & THOMAS, PLLC, 625 SLATERS LANE, FOURTH FLOOR, ALEXANDRIA, VA, 22314, US

(73) Assignee: CoreTech System Co., Ltd., Hsinchu City (TW)

(21) Appl. No.: 11/345,314

(22) Filed: Feb. 2, 2006

(30) Foreign Application Priority Data
Oct. 27, 2005 (TW) 094137695

(51) Int. Cl. G06T 17/00

(52) U.S. Cl. 345/420

(57) ABSTRACT

An automated mesh creation method for automatically creating meshes for a model that may be applied in a mold flow analysis. The method includes the steps of creating surface meshes for the model from a CAD model or a STL file; refining the surface meshes; creating boundary solid meshes for the model; creating interior solid meshes for the model; improving the quality of the boundary solid meshes or the interior solid meshes; performing a true 3D model flow analysis for the model according to the surface meshes, the boundary solid meshes and the interior solid meshes; and adjusting the surface meshes, the boundary solid meshes or the interior solid meshes according to any inaccuracy of the mold flow analysis.

### BACKGROUND OF THE INVENTION

1. Field of the Invention

The present invention relates to a mesh creation method, and, more particularly, to an automated mesh creation method for injection molding flow simulation application.

2. Description of the Related Art

Generally, most CAE (Computer Aided Engineering) softwares are based on the application of various numerical analyses methods such as FDM, FEM, FVM and FBM, where a mesh, i.e., the numerical discretization of the analysis spatial domain is an essential step for the numerical simulation. The meshing procedure is performed on the simulated model before running the CAE analysis. Consequently, the quality of the mesh created directly affects the accuracy and efficiency of the numerical simulation, which subsequently affects the interpretation of these analysis results and the predictive capability of the CAE software.

In the three-dimensional engineering application, three dimensional solid elements are generated for a three dimensional solid model when meshing procedure was done. As shown in FIG. 5, basically there are four types of three dimensional elements: hexa element 51, prism element 52, tetra element 53 and pyramid element 54 respectively.

There are two prior art methods for creating three dimensional solid meshes:

The first type mesh is a non-structural mesh style including the tetra element 53 and pyramid element 54. These types of meshes can be created for any free boundary by fast, fully automatic mesh approach such as Advancing Front Approach or Delanuy Mesh Generation Approach. However, these types of meshes are usually highly distorted and have poor mesh quality for the injection molding flow simulation application. Moreover, control of the number of layers in the mesh to improve the numerical simulation resolution is not easy, and this leads to the poor numerical prediction of the CAE simulation.

The second type is a structural mesh style, which includes the prism element 52 and the hexa element 51. These types of meshes can provide good mesh quality, and control of the number of mesh layers is relatively easy in compared to the automatic tetra mesh approach. However, these types of meshes are not easy to create, and require considerable amounts of time and efforts even for an experienced user to generate this type of meshes.

Prior art patents (such as U.S. Pat. Nos. 5,896,303 and 6,512,999), and related documents (such as “Boundary Layer Meshing for Viscous Flows in Complex Domains”, Rao V. Garimella and Mark S. Shephard, Scientific Computation Research Center) disclose methods of creating boundary layer meshes, and all of these methods may be applied in field of calculating fluid dynamics (CFD). However, the prior art technology does not disclose creation of boundary meshes for interior flow field, especially for the injection molding flow simulation that has essentially different flow characteristics in compared to the exterior flow field that was addressed by the cited approach.

Basically, mold flow simulation and standard computational fluid dynamics (CFD) are very similar in the governing equation and base numerical simulation approach, they both must deal with dramatic boundary layer flow velocity and temperature changes, and creation of three dimensional boundary layer meshes helps to increase the accuracy of the analysis results. But, in general, the computational fluid dynamics analysis is used for simulating external flow field, whereas the mold flow simulation processes are related to internal flow. In addition to this, the typical thickness of an injection molding part is about 1 to 2 mm. The part geometry is very complicated, The temperature gradient is sharp (changes from 70° C. to 300° C. across 1 mm thickness distance), This also increases the difficulty and challenge in creating quality meshes for the mold flow analysis purpose.

Therefore, it is desirable to provide an automated mesh creation method that automatically creates meshes for a model for application in a mold flow analysis. It is additionally desirable that the method integrates two different types of meshes, automatically create three dimensional meshes while controlling the number of layers and quality of the meshes, and apply the created three dimensional meshes to a real three dimensional mold flow analysis.

### SUMMARY OF THE INVENTION

The present invention provides an automated mesh creation method for automatically creating meshes for a model that may be applied in a mold flow analysis.

The method comprises: creating a plurality of surface meshes for the model from a CAD model or a stereolithography (STL) file; refining the plurality of surface meshes; creating a plurality of boundary solid meshes for the boundary layer of the model; creating a plurality of interior solid meshes for the model interior; improving the quality of the plurality of boundary solid meshes or the plurality of interior solid meshes; performing a true 3D mold flow analysis of the model according to the plurality of surface meshes, the plurality of boundary solid meshes and the plurality of interior solid meshes; and adjusting the plurality of surface meshes, the plurality of boundary solid meshes or the plurality of interior solid meshes according to any inaccuracy of the CAE analysis result.

In one embodiment of the present invention, the plurality of boundary solid meshes are the plurality of prism solid meshes or the plurality of hexa solid meshes; and the plurality of interior solid meshes are the plurality of tetra solid meshes or the plurality of pyramid solid meshes.

In one embodiment of the present invention, the present invention refines the plurality of surface meshes is performed according to the thickness and/or curvature of the model; the present invention improves the quality of the plurality of boundary solid meshes or the plurality of interior solid meshes is performed according to a predetermined quality standard.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method of the present invention.

FIG. 2 is a schematic drawing of a plurality of surface meshes generated by the present invention.

FIG. 3 is a schematic drawing of a plurality of refined surface meshes according to the present invention.

FIG. 4 is a schematic drawing of a plurality of boundary solid meshes and a plurality of interior solid meshes generated by the present invention.

FIG. 5 shows different meshes of the present invention.

### DETAILED DESCRIPTION OF THE PREFERRED EMBODIMENT

The present invention provides an automated mesh creation method for automatically creating meshes for a model, particularly the boundary layer meshes of the model, which may be applied in a mold flow analysis.

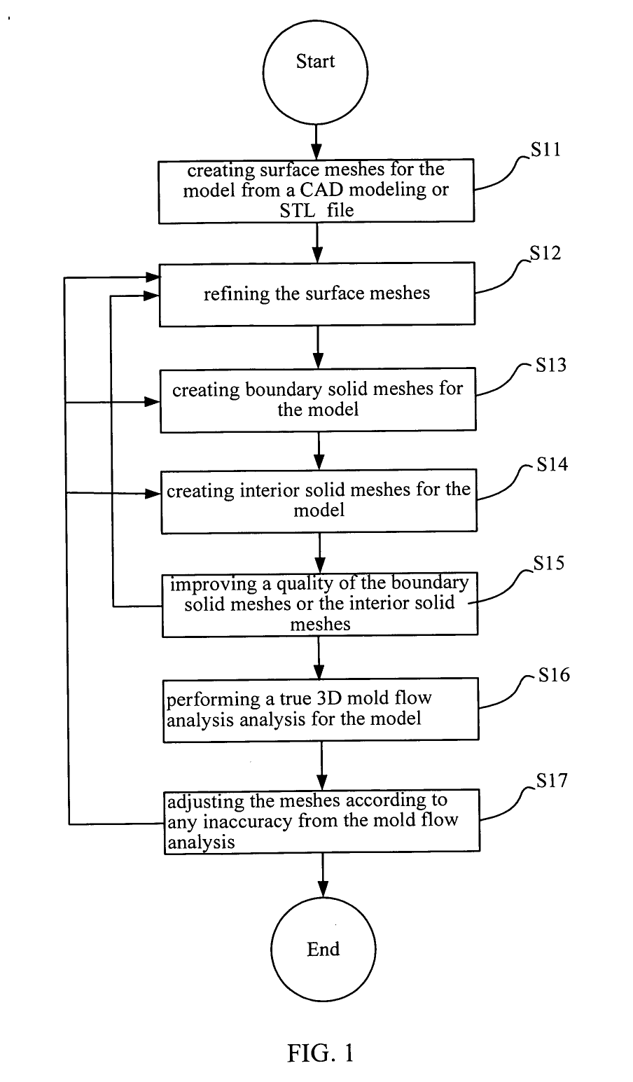

Please refer to FIG. 1. FIG. 1 is a flowchart of a method of the present invention. As shown in FIG. 1, the method of the present invention comprises steps S11, S12, S13, S14, S15, S16 and S17, and these steps are all automatically performed.

A shown in FIG. 1, in step S11 of the method of the present invention, a plurality of surface meshes are created from the surfaces of the geometry model. The geometry model can be obtained from CAD or a stereolithography (STL) file. The technology related to creating surface meshes by way of CAD models or stereolithography files is a very well-known technology, and so requires no further description.

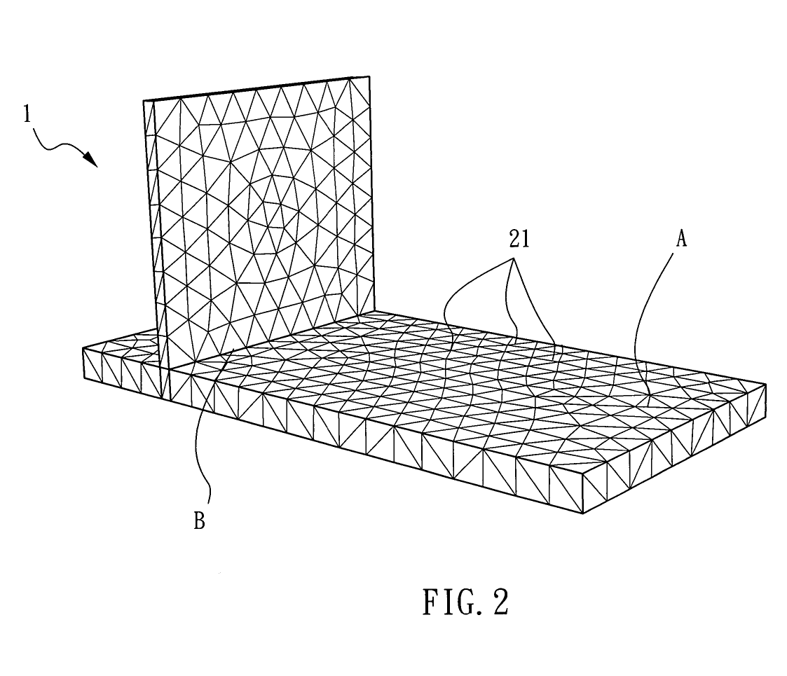

As shown in FIG. 2, in step S11, the plurality of surface meshes 21 are generated on the surface of the model 1 to approximate the geometry of the model 1. After step S11, the present invention can build a plurality of triangle meshes 21 on the surface of the model 1 to obtain the basic geometry of the model 1 for the next step. Alternatively, in another embodiment of the present invention, after step S11, the present invention can build a plurality of quadrangle meshes (not shown) on the surface of the model 1 to obtain the basic geometry of the model 1 for the next step.

Generally, the plurality of surface meshes 21 generated in step 11 do not meet the requirements of mold flow analysis and must be refined. Therefore, after step S11, in step S12, the plurality of surface meshes 21 are refined to conform to the requirements of the mold flow analysis.

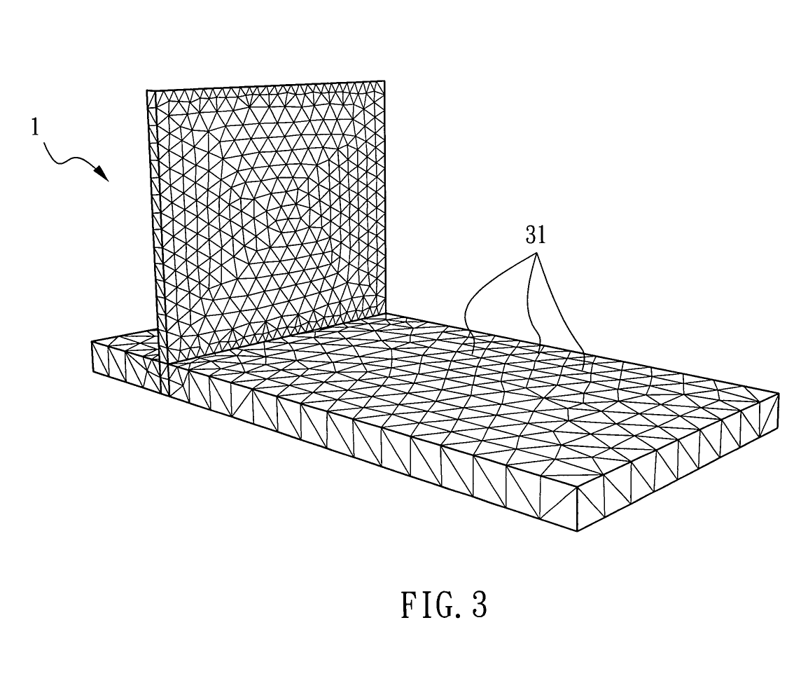

In step S12, the present invention refines the plurality of surface meshes according to the different thicknesses of different areas on the model 1. Alternatively, the present invention may refine the plurality of surface meshes according to whether all normals of the plurality of surface meshes 21 are aligned in the same direction. For example, at a relatively flat area on the model 1 (such as the area marked “A” in FIG. 2), the normal direction of each surface mesh towards the same direction (which means that the dot product of each two unit normal vectors is 1), indicating that the appearance is good and requires less refinement. For a relatively curved area on the model 1 (such as the area marked “B” in FIG. 2), the normal vectors of the surface meshes are not aligned in the same direction (which means that the dot product of each two unit normal vectors is less than 1), indicating that the appearance is poor. The present invention can improve the appearance by generating much smaller surface meshes. Please refer to FIG. 3. FIG. 3 is a schematic drawing of a plurality of refined surface meshes on the model 1 according to the present invention.

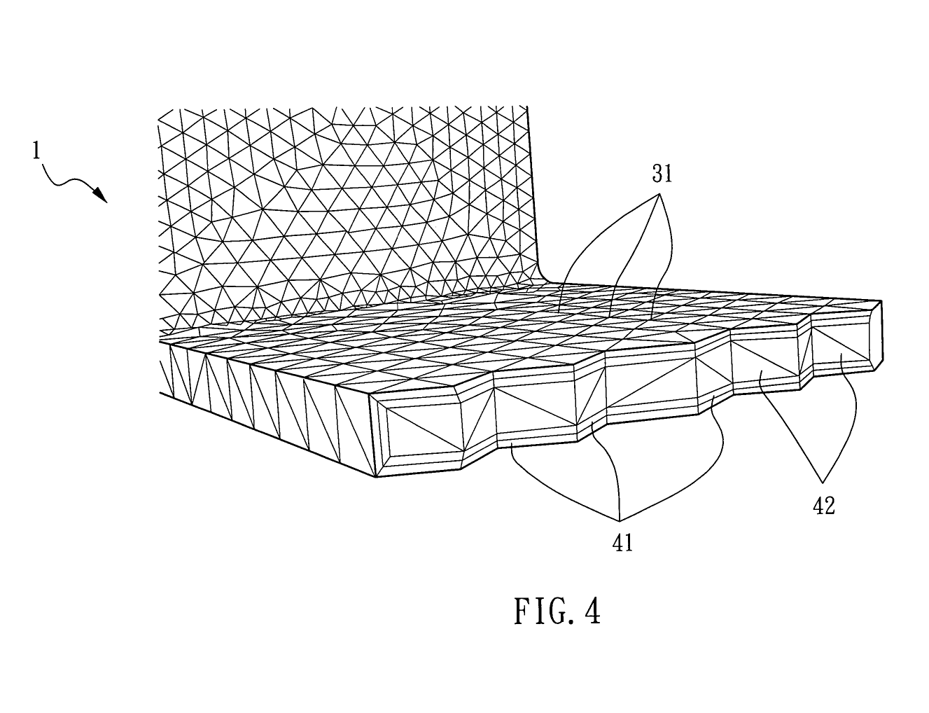

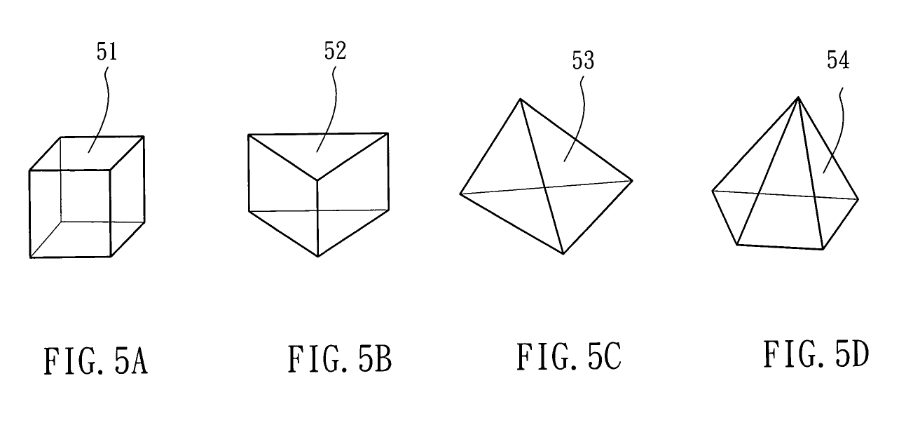

Next, after step S12, step S13 is performed. As shown in FIG. 4, a plurality of boundary solid meshes 41 are created for the boundary layer of the model 1. The plurality of boundary solid meshes 41 can be composed of many hexa solid meshes 51, as shown in FIG. 5A. Alternatively, the boundary solid meshes 41 may be composed of many prism solid meshes 52, as shown in FIG. 5B.

After step S13, step S14 is performed. As shown in FIG. 4, pluralities of interior solid meshes 42 are created in the interior of the boundary layer of the model 1. The plurality of interior solid meshes 42 can be composed of many tetra solid meshes 53 as shown in FIG. 5C, or may be composed of many pyramid solid meshes 54, as shown in FIG. 5D.

Then, step S15 is performed optionally, improving the quality of the plurality of boundary solid meshes 41 or the plurality of interior solid meshes 42 according to a predetermined quality standard (such as a quality table). For example, the predetermined quality standard may be set according to the predetermined mold flow analysis requirements, such as the aspect ratio, skewness, orthogonality or smoothness of each mesh. When the quality of the boundary solid meshes 41 or the interior solid meshes 42 are not up to the predetermined standard, the present invention can improve these meshes. Alternatively, the present invention can re-perform step S12 (refining the surface meshes), step S13 (creating the plurality of boundary solid meshes 41) or step S14 (creating the plurality of interior solid meshes 42) to create better meshes. Step S15 is therefore a selective step, and not a necessary step. For example, when the predetermined mold flow analysis requirements are loose, the present invention can skip step S15.

Next, in step S16, a real three dimensional mold flow analysis is performed according to the plurality of surface meshes 31, the plurality of boundary solid meshes 41 and the plurality of interior solid meshes 42 created in above steps S11-S15.

Finally, in step S17, an adaptive meshing technology is utilized to adjust and re-perform step S12 (refining the surface meshes), step S13 (creating the plurality of boundary solid meshes 41) or step S14 (creating the plurality of interior solid meshes 42) according to inaccuracy from the mold flow analysis in step S16. For example, if the plurality of surface meshes 31, the plurality of boundary solid meshes 41 or the plurality of interior solid meshes 42 at some area of the model 1 have a low element density that causes the resolution of temperature analysis result is not good during the mold flow analysis, the present invention may perform step S17 to adjust and re-create meshes for this area.

The present invention thus automatically creates meshes, and provides the following benefits:

1. The present invention reduces the number of required mesh element count and achieves the requirements of the mold flow analysis.

2. The present invention provides high accuracies for real three dimension mold flow analysis in an internal flow under dramatic changes of temperature, velocity, or stress.

3. The steps of the present invention may all be performed automatically, which can reduce the cost, time, and human error factors that arise in manual procedures.

Although the present invention has been explained in relation to its preferred embodiment, it is to be understood that many other possible modifications and variations can be made without departing from the spirit and scope of the invention as hereinafter claimed.

What is claimed is:

1. An automated mesh creation method for automatically creating meshes for a model that may be applied in a mold flow analysis, the method comprising:
creating a plurality of surface meshes for the model from a CAD model or a stereolithography (STL) file;
refining the plurality of surface meshes;
creating a plurality of boundary solid meshes for a boundary layer of the model;
creating a plurality of interior solid meshes for an interior of the model;
improving a quality of the plurality of boundary solid meshes or the plurality of interior solid meshes;
performing a true 3D mold flow analysis for the model according to the plurality of surface meshes, the plurality of boundary solid meshes and the plurality of interior solid meshes; and
adjusting the plurality of surface meshes, the plurality of boundary solid meshes or the plurality of interior solid meshes according to any inaccuracy of the mold flow analysis.

2. The method as claimed in claim 1, wherein the plurality of boundary solid meshes are a plurality of prism solid meshes or a plurality of hexa solid meshes.

3. The method as claimed in claim 1, wherein the plurality of interior solid meshes are a plurality of tetra solid meshes or a plurality of pyramid solid meshes.

4. The method as claimed in claim 1, wherein the step of refining the plurality of surface meshes is performed according to a thickness of the model.

5. The method as claimed in claim 1, wherein the step of improving the quality of the plurality of boundary solid meshes or the plurality of interior solid meshes is performed according to a predetermined quality standard.

6. An automated mesh creation method for automatically creating meshes for a model for application in a mold flow analysis, the method comprising:
creating a plurality of surface meshes for the model from a CAD model or a stereolithography (STL) file;
creating a plurality of boundary solid meshes for a boundary layer of the model;
creating a plurality of interior solid meshes for an interior of the model; and
performing a true 3D mold flow analysis for the model according to the plurality of surface meshes, the plurality of boundary solid meshes and the plurality of interior solid meshes.

7. The method as claimed in claim 6 further comprising refining the plurality of surface meshes prior to creating the plurality of boundary solid meshes for the boundary layer of the model.

8. The method as claimed in claim 6, wherein the plurality of interior solid meshes are a plurality of tetra solid meshes or a plurality of pyramid solid meshes.

9. The method as claimed in claim 6, wherein the plurality of boundary solid meshes are a plurality of prism solid meshes or a plurality of hexa solid meshes.

10. The method as claimed in claim 6, further comprising improving a quality of the plurality of boundary solid meshes or the plurality of interior solid meshes prior to performing the true 3D mold flow analysis for the model according to the plurality of surface meshes, the plurality of boundary solid meshes and the plurality of interior solid meshes.

11. The method as claimed in claim 6 further comprising adjusting the plurality of surface meshes, the plurality of boundary solid meshes or the plurality of interior solid meshes according to any inaccuracy of the mold flow analysis.

12. The method as claimed in claim 7, wherein the step of refining the plurality of surface meshes is performed according to a thickness of the model.

13. The method as claimed in claim 10, wherein the step of improving the quality of the plurality of boundary solid meshes or the plurality of interior solid meshes is performed according to a predetermined quality standard.
